(19) United States
(12) Patent Application Publication
(10) Pub. No.: US 2013/0268529 A1
(43) Pub. Date: Oct. 10, 2013

(54) Systems and Methods for Contact Management and Referral Engine

(71) Applicant: Phillip Butts, Pacific Palisades, CA (US)

(72) Inventor: Phillip Butts, Pacific Palisades, CA (US)

(21) Appl. No.: 13/632,057

(22) Filed: Sep. 30, 2012

Related U.S. Application Data
(60) Provisional application No. 61/542,060, filed on Sep. 30, 2011.
(60) Provisional application No. 61/606,159, filed on Mar. 2, 2012.

(51) Int. Cl. G06F 17/30

(52) U.S. Cl. CPC G06F 17/30595
USPC 707/736

(57) ABSTRACT

The present system allows business people to organize, receive and transfer key information about themselves and their contacts through the use of videos, audio and text. Users can create their own profile video (either from a pre-set group of videos or videos they create and name themselves) that may then be disseminated to their entire contact list, prompting their network to join the system. The system in one embodiment provides an effective way to give referrals to others as a path to in turn receiving referrals. The system also provides a way for users to associate a plurality of multimedia clips with then profile, so that other users can easily learn what a user does, what they look like, and what referrals would be of most use to the user. The system provides templates and guidelines to creating the multimedia clip and creates an easy platform for sharing the information with others. This would include an easy, effective way for members of groups, clubs, organizations, etc, to become more familiar with their members thus providing a more effective business and personal engagement. All of this is accomplished in a controlled, secure environment.

This patent application claims priority to U.S. Provisional Patent Application 61/542,060 filed on Sep. 30, 2011 and U.S. Provisional Patent Application 61/606,159 filed on Mar. 2, 2012, both of which are incorporated by reference herein in their entirety.

### BACKGROUND

Receiving and giving person-to-person referrals is often a key to new business development. Such referrals can be more effective than advertising and marketing, and trusted referrals give companies access to insider knowledge available nowhere else. Similarly, efficiently organizing and indexing, contacts can mean the difference between keeping; business relationships active and ongoing, or losing contact with important people. Typically a person ull have a group of contacts that are important business and/or personal relationships. Ofien, person ill“network” with their contacts in an effort to generate business.

In the past, contact management was a matter of building a rolodex and having the discipline to regularly communicate with important contacts on a regular basis. With the advent of computer systems and networks such as the internet, the prior art has attempted to provide new methods for contact management and use.

For example, a platform called “LinkedIn” is a social networking site for people in professional occupations and is designed for professional networking. The site is designed for a user to maintain a list of contact details for others with whom they have, or desire to have, a professional relationship, or otherwise want to be connected with One goal of the site is to be able to take advantage of a user's existing contacts to meet and/or obtain information about others who may have a professional relationship with one of the user's own contacts. It is a “six degrees of separation” approach for networking. A disadvantage with prior art tools such as this is that they do not take advantage of all of the existing technology available on networks such as the internet. Another disadvantage is that such systems do not provide useful, compact, and up to date information. (Most often users are connected to other professionals with whom they have no history, rather than utilizing current trusted relationships)

Another prior art approach is the user of online address books such as Plaxo. Such prior art approaches provide an automatic updating of contact information. However, such approaches are little more than electronic rolodexes and do not provide the tools for genuine referral optimization.

### SUMMARY

The present system allows business people to organize, receive and transfer key information about themselves and their contacts through the use of videos, audio and text. Users can create their own profile video (either from a pre-set group of videos or videos they create and name themselves) that may then be disseminated to their entire contact list, prompting their network to join the system. The system in one embodiment provides an effective way to give referrals to others as a path to in turn receiving referrals. The system also provides a way for users to associate a plurality of multimedia clips with then profile, so that other users can easily learn what a use does, what they look like, and what referrals would be of most use to the user. The system provides templates and guidelines to creating the multimedia clip and creates an as platform for sharing the information with others. This would include an easy, effective way for members of groups, clubs, organizations, etc, to become more familiar with their members thus providing a more effective business and personal engagement. All of this is accomplished in a controlled, secure environment.

These and further embodiments will be apparent from the detailed description and examples that follow.

### BRIEF DESCRIPTION OF THE DRAWINGS

The present system is herein described, by way of example only, with reference to the accompanying drawings, wherein:

FIG. 1 is a flow diagram illustrating the operation of an embodiment of the system.

FIG. 2 illustrates an embodiment of a contact profile in an embodiment of the system.

FIG. 3 illustrates an interface of multimedia files in an embodiment of the system.

FIG. 4 illustrates a multimedia creation mode in one embodiment of the system.

FIG. 5 illustrates a multimedia clip creation guide in an embodiment of the system.

FIG. 6 illustrates examples of teleprompter scripts in an embodiment of the system.

FIG. 7 is a flow diagram illustrating the operation of multimedia content creation in an embodiment of the system.

FIG. 8 is a display illustrating a group match mode in an embodiment of the system.

FIG. 9 is a display showing grow match results in an embodiment of the system.

FIG. 10 illustrates a dashboard display in an embodiment of the system.

FIG. 11 is a flow diagram illustrating an embodiment of the referral process of the system.

FIG. 12 is an example computer embodiment for implementing the system.

### DETAILED DESCRIPTION

The present system solves a number of problems associated with prior art contact management systems. One of the problems is the recall problem associated with current systems. After receiving a business card or contact from a new acquaintance, a user may forget many details about that person as time passes. Even if the person took a few notes about the new contact, the notes many not be meaningful after a week or so. In a business networking environment, when people are meeting dozens of new contacts, current systems are ill suited for useful information exchange. Even if they agree to follow up and meet the person in the future, they may not even remember something as simple as their physical appearance.

The present system provides a system where it is easy to provide referrals to others in a contact list. The belief is that by giving referrals to others, the user increases their own chance of getting referrals back to themselves. One of the items of information about a contact that increases the ability to provide referrals is to know exactly what the contact does, and to whom the contact would like to be referred. In other words, what specific person or type of person is the best for that contact to meet. For example, some contacts may desire to meet the general counsel of a company in order to maximize their opportunity for creating a business relationship, others may desire to meet a CFO, an HR manager, a marketing exec, and the like. Knowing the key targets of the contact allows a user to determine if they themselves know any contacts in that category to refer the contact. Knowing what the contact does is also key for optimizing the likelihood that the referral part will have an interest. The system also works in a controlled, secure environment where information, ie videos, audio or text, is only sent/referred to others after approval has been given by the creator of the content.

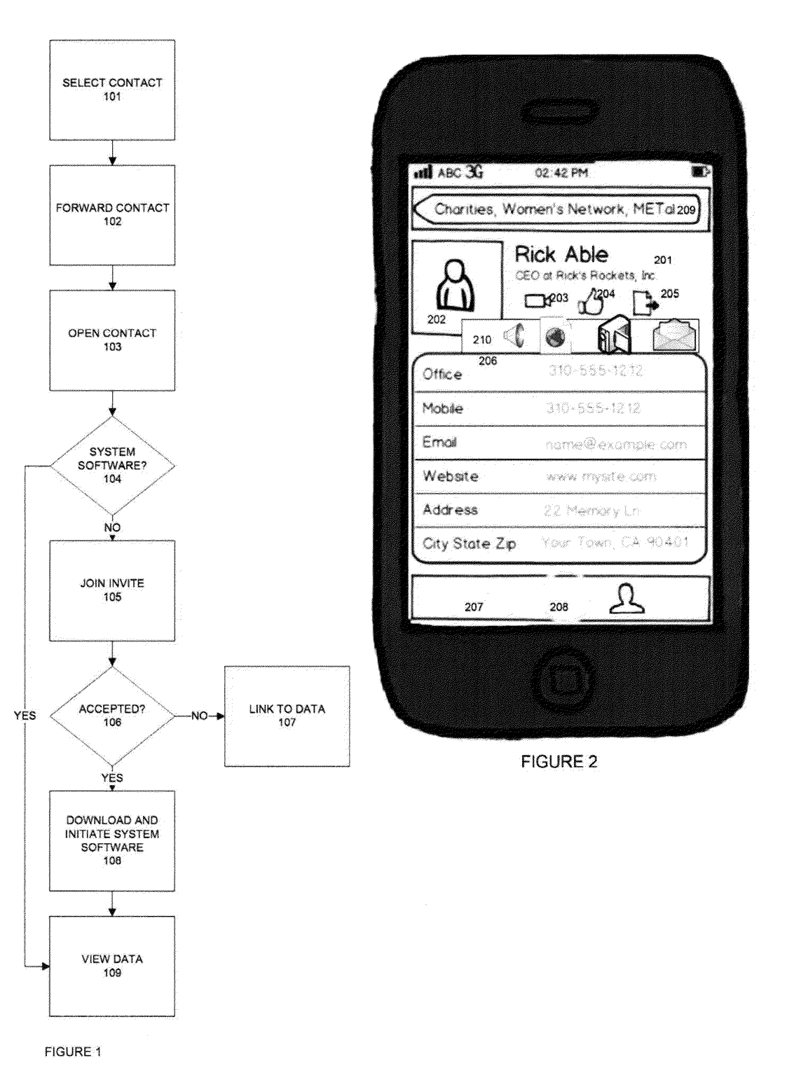

The system is implemented using its own software environment. FIG. 1 is a flow diagram illustrating the operation of an embodiment of the system when transferring/referring a contact to another person. At step 101 the user selects a contact from the user's contact list that is to be forwarded to another person. The user then selects the video, audio or text of the contact to be transferred/referred to the other person. At step 102 the user forwards the contact and their video, audio or text, to the other person. Before the information is sent, a notice is sent to the contact asking for approval to have their information sent to the other person. This can be accomplished via email, text, through social media, and the like. Once approval has been given by the contact, the information is sent to the other person. At block 103 the recipient opens the contact. At decision block 104 the system determines if the recipient already has the system software. If not, the system provides a message to the recipient inviting them to download the system software at step 105. If the recipient already has the software at block 104, the system proceeds to step 109 to view the data.

At decision block 106, the system determines if the recipient has accepted the offer of the system software. If not, the system provides links that will enable the recipient to view the contact information at step 107. If the user opts to accept the software, the system proceeds to step 108 and the software is downloaded and initialized on the recipient system.

At step 109 the recipient views the data using the system software and the system adds the contact data to the recipients contact database.

System Contact Profile

The system provides a unique format for contact information. In one embodiment, the contact format comprises a combination of text and multimedia files. The text component of the contact format includes traditional information such as name, address, contact information, title, links, and the like. The multimedia portion of the format includes a number of multimedia files that are useful in optimizing the value of the contact information.

The multimedia files may be video and/or audio files, as well as image files. In one embodiment, a number of multimedia templates are defined with specific limits and boundaries that have been found to optimize value for the contact person and to create useful expectations to any recipients of a system contact.

In one embodiment, the user will record a 15, 30, 60, 90, and/or 120 second profile video that consists of that person describing what it is that they do. This is more useful than a mere job title, as it allows recipients of the contact profile to get a more detailed understanding of the contact, their expertise, their companies strengths, what sets them apart from the competition, and the like. The system includes tips and guides on creating the video profile, so that a consistency is achieved across the system platform, leading to better optimized results.

An example of a system contact profile as it would appear on a device such as a smartphone is illustrated in FIG. 2. The example is shown on a smart-phone display but the system may show contacts on any suitable device including a computer, laptop, pad computer, FDA, and the like. The profile comprises a region 201 that includes the name and picture 202 of the contact. The region 201 includes a number of icons that can be useful including the multimedia clip icon 203, the “like” icon 204, and the document icon 205. The multimedia icon 203 includes a numeric indicator showing how many multimedia clips are associated with this contact that have been sent to the user. In the example shown it is 5 clips. The icon 204 represents the number of referrals that contact has received from the user (e.g. 34). Icon 205 represents the number of referrals sent by the contact to the user (e.g. 29).

The user can select the icon 203 and be taken to a screen that presents the multimedia clips and allows the user to select one for viewing or for other actions. One of the advantages of the system is that the user may send all or part of his contact's information to a third party. For example, a user may decide to only forward a single clip of the plurality of multimedia clips that are present in the profile to a recipient. The system allows this to be done. If this particular contact were to update his multimedia clips by replacing one, deleting one, and/or adding one, the contact profile would be updated automatically. There will be some indicator that a change has taken place so that the user will realize that there has been an update.

Region 206 of the profile presents more traditional contact information including phone numbers, addresses, web sites, email, social media accounts, and the like. (A lower region 207 includes tools that the user can use to accomplish things related to the profile. For example, selecting the camera icon 208 in region 207 allows the user to create a new multimedia clip to include with and associate with the profile. It is contemplated that tapping on the display may initiate an edit mode in an embodiment of the system.

In one embodiment, the icons in region 207 will be displayed in all screens of the system, allowing the user to instantly go to a desired page or function with ease. The options include the group screen, contact, create a multimedia clip (208). My Profile page, and a standard start page.

The profile also includes a region 209 that scrolls all of the groups to which the user belongs and also highlights those groups the contact also belongs to for quick reference.

Region 210 is a scrollable or swipeable bar that includes a number of contact centric icons that can be used to generate functions that relate specifically to that contact. In the example shown, the bar includes icons for audio note, globe (for geolocation), video camera, and mail icon. Others may be displayed here as appropriate. The globe icon is described in more detail below but when selected, it will bring up a map centered on the contacts address and will show other contacts in the same geographical region.

The audio and video icons will bring up a screen for recording audio or video that will be sent to the contact and will be associated with the contact page. The email icon will cause all communications between the user and the contact via email to be displayed in a list on the display. This automatic and contact-centric functionality is a useful tool in the system.

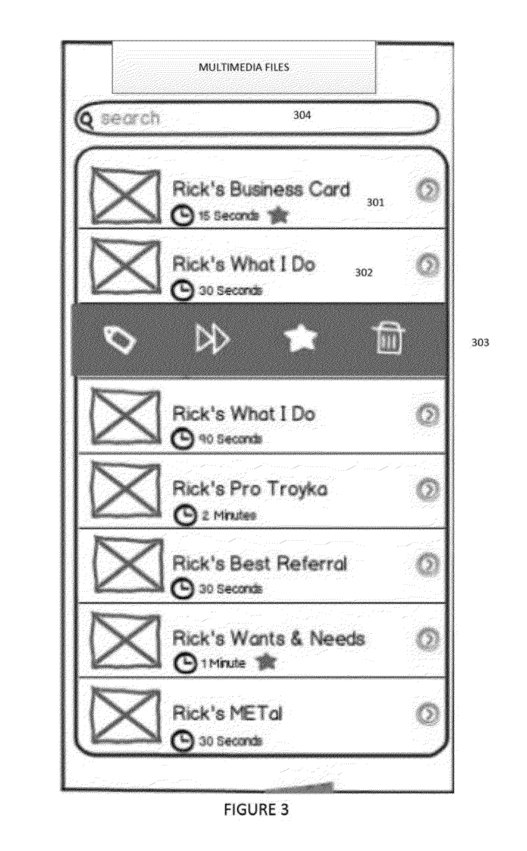

FIG. 3 illustrates additional profile information that can be displayed in a number of ways. This display may be accessed by scrolling the screen of FIG. 2 down or by swiping sideways, by clicking on the multimedia icon 203, or by any other suitable method.

The display of FIG. 3 shows the available multimedia files of a user that are associated with their profile. Each clip shows its title and length. For example, clip 301 is titled “Rick's 15 Second Business Card” and is 15 seconds in length. Clip 302 is titled “Rick's What I Do” and is 30 seconds in length but can be 60 or 90 seconds. Swiping on a clip opens up an additional action region 303 that the user can use to perform certain actions such as tag, send, favourite, and delete.

Multimedia Clip Creation

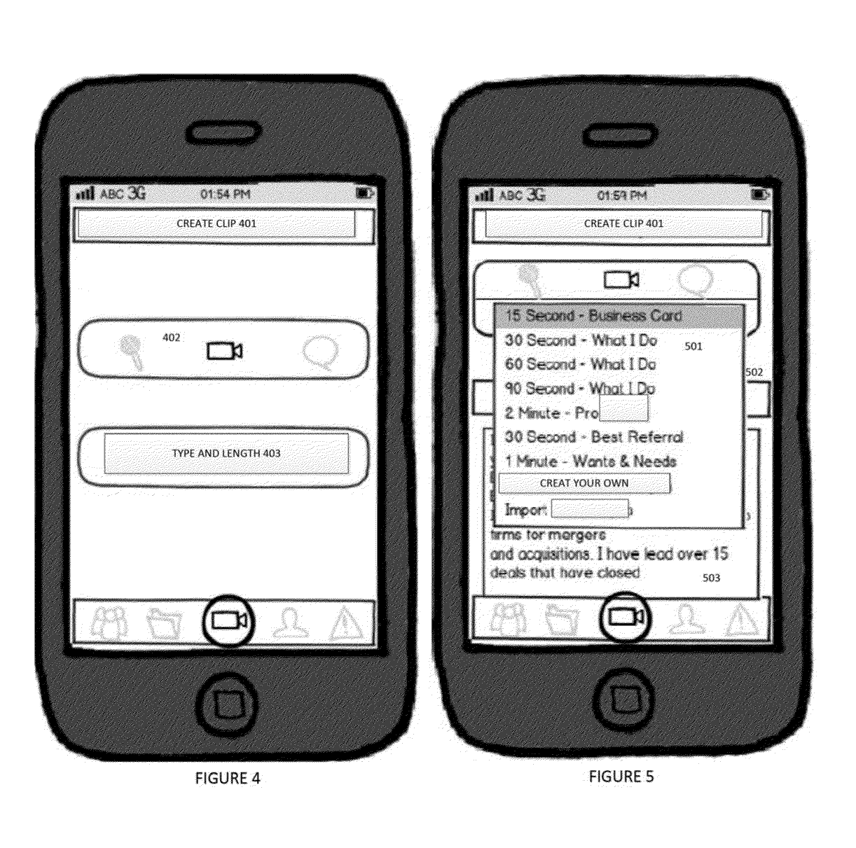

Multimedia creation is performed on the users “Profile” page accessed by tapping on the “Profile” icon that sits on the bottom of each screen. One of the advantages of the system is that it provides a template, tutorial, and guide for creating multimedia files for use with the contact profiles. It should be noted that the system is capable of importing multimedia files created using other applications. Although the system recommends clips of specific lengths (e.g. 15, 30, 60, 90, 120 seconds) the system contemplates that other length clips can be used without departing from the scope and spirit of the system. FIG. 4 is an example of the display of an embodiment of the system when clip creation has been selected.

The system uses the recording capability of the device on which the software is loaded in one embodiment of the system. The display in clip creation mode allows the user to select, in region 402, the type of clip that will be produced, including video, text, audio, and the like. Region 403 allows the user to select the type and length of the clip from a number of predetermined types and lengths, including, but not limited to, 15, 30, 60, 90, 120 seconds and the like.

To begin the creation of the clip the user clicks on button 403 and is taken to the clip creation interface that will assist the user in creating the clip. This has been found to be helpful to both guide the user to make an optimized clip as well as to provide a consistency of presentation in the system so that users have some idea of what to expect when a clip is selected for playback.

FIG. 5 illustrates an embodiment of the clip creation interface. Pull-down menu 501 allows the user to select a video type and length. (This assumes the user is in video mode, if the user has selected text or audio, then text type or audio type would be the selections available.) For example, there is a type called “What I Do” with different lengths of time that the user can select. The user ma select one of the pre-defined categories of the system. It has been found that providing consistent naming, paradigms can increase the usefulness and acceptance of the system. However, the user may select “Create Your Own” and is able to edit and change the name of the clips as desired. Additionally, the user can select a “Pro” level mode or “Import” a clip made in some other system.

When the user selects one of the types of videos in pull down menu 501, the system presents a description of the type of text that might be useful for such a clip. The interface includes a region 502 for teleprompter functionality, so that the user need not memorize the script of what to say. The user can face the phone towards the user and see the script 503 for suggestions for script content) in front of the user during filming. In addition, a progress bar or countdown timer can be provided, to aid the user in keeping the clip within desired time constraints. In one embodiment, the system can flash or give some indication during the last few (e.g. 10) seconds of a recording session so that the user can be alerted to wrap up. Because the user is doing this himself, the user has the ability to re-record the clip a number of times until getting a satisfactory take. In one embodiment, the length of the clip in the first pre-set categories must be less than or equal to in length to their corresponding categories stipulated length, or they will be rejected.

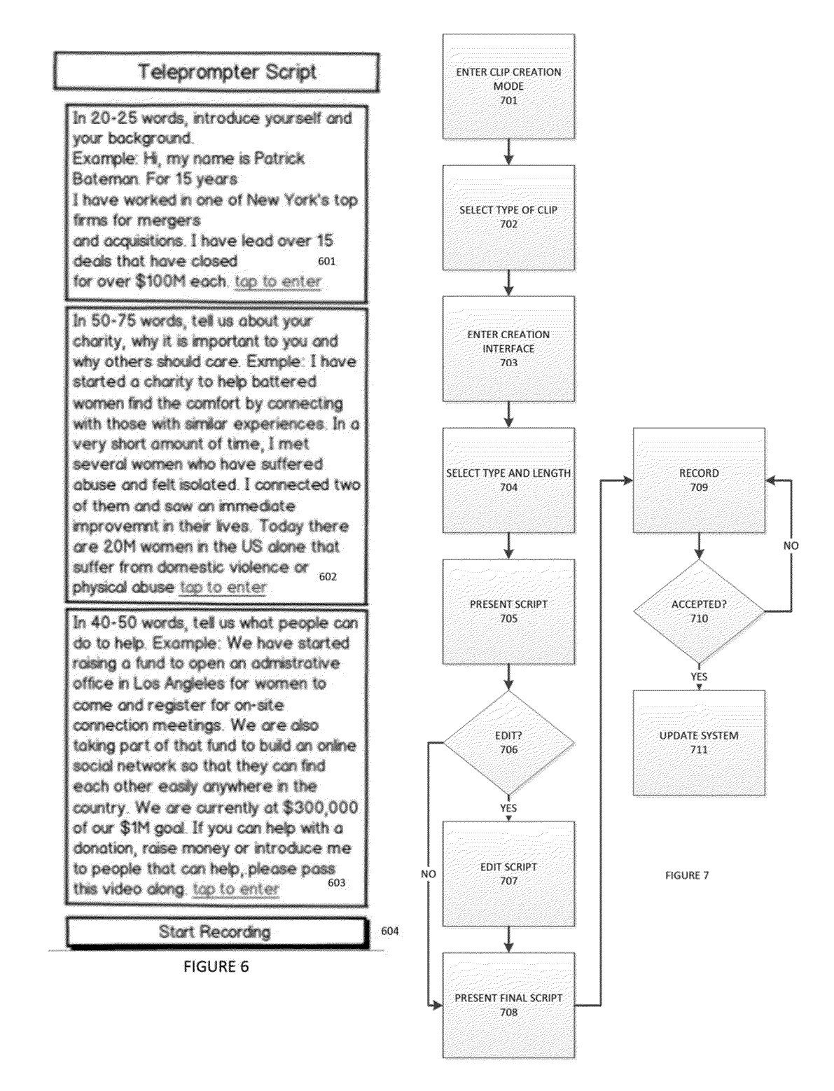

FIG. 6 is an example of a possible teleprompter script for a number of types of videos or audio clips. Each section 601, 602, or 603, describes the number of words that might be appropriate for a particular length of clip and suggest the types of things that the user should talk about. Each suggested region includes a “tap to enter” tag that allows the user to enter their own text that can then be read back by the user during recording. When entering text, the system may provide the word count automatically so that the user can keep track of an appropriate length script.

In one embodiment, the system provides a plurality of backgrounds that can be digitally inserted behind the image of the user for the in multimedia clip. These can be office cityscapes, and the like. The user may also upload backgrounds for use in the clips as desired, including company logos and the like. The result is a professional and consistent looking multimedia presentation that can be used as a business and referral tool.

FIG. 7 is a flow diagram illustrating the operation of multimedia clip generation in one embodiment of the system. At step 701 the user enters clip creation mode. At block 702 the user selects the type of clip to be made (e.g. audio, video, or text). At step 703 the user selects the length and type button 403 and enters creation interface mode.

At step 704 the user selects the type and length of the clip to be created (e.g. see drop down menu 501 of FIG. 5). At step 705 the user is presented with a teleprompter script. At decision block 706 it is determined if the user will edit the script. If so, the system proceeds to edit step 707. If not or after editing step 707, the system proceeds to step 708 and presents the script. At this point the system determines the scroll rate for the teleprompter script based on the length of clip. At step 709 the recording, begins and is stopped after the selected time. At decision block 710 the system determines if the user has accepted the clip. If so, the system is updated at step 711. If not, the system returns to step 709 to re-record.

Categorizing Contacts

The system provides other advantages in addition to the associated multimedia clips that can be created. One feature is the manner in which contacts can be organized. Many business users belong to a plurality of groups, including networking groups, professional organizations, charities, dubs, social groups, and the like. The system provides both a method for identifying each group in which you are a member, as well as all groups of which each contact is a member. The system also provides a sophisticated Venn sorting of groups to identify specific contacts that may share particular combinations of interest.

In one embodiment, the system displays the groups to which a user belongs in a scrolling field at the top of every contact profile (including the user's own profile). This is described in field 209 of FIG. 2. In one embodiment, when a user is looking at a contact, the user's own groups are scrolling in field 209. For any group in which the contact is also a member, that group will be highlighted in some manner, or some other indication will, be made that the user and the contact share a group. The scrolling of the field may be continuous or it may be prompted by mousing over the left or right areas of field 209, or via arrow keys. The horizontal bar on the top that has the “Group” icons on it in which a user can swipe to the left to reveal more, also can be flipped over, with a downward swipe, to review all of the “Categories”.

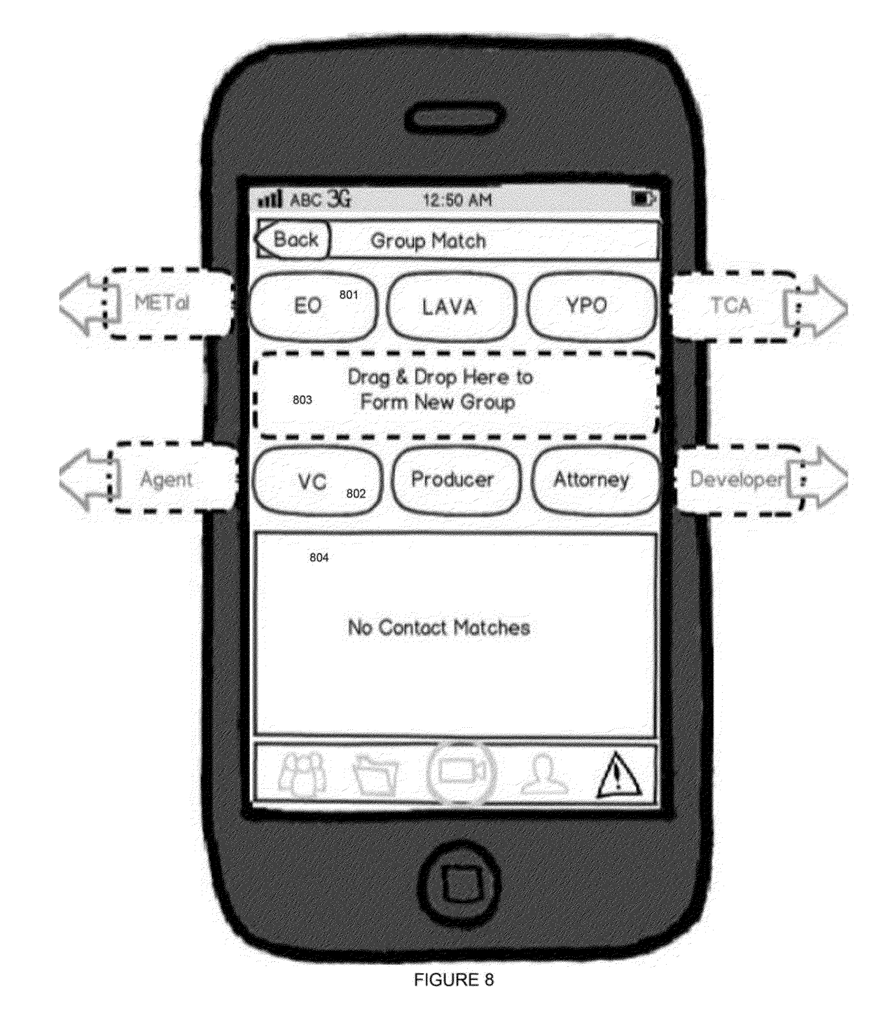

In some instances, the user may want to identify all contacts that share one or more groups or categories with the user. FIG. 8 illustrates a group match interface that provides a tool for accomplishing this. When in this mode, the system displays a scrolling, field 801 that shows all of the groups to which the user belongs (e.g. EO, LAVA, YPO, and the like) referred to in one embodiment as “external groups”. A second scrolling field 802 shows all the categories representing the contacts in the user's contact list (e.g. VC, Producer. Attorney, and the like) and referred to in one embodiment as “internal groups”. The user can define the internal groups and assign a contact to one or more internal groups as desired.

If the user would like to identify all contacts that share certain groups and characteristics, the user simply can drag and drop the appropriate group(s) and/or category(ies) to field 803. Field 803 will show the name of each group or category that has been dragged into the field. Field 804 will show all contacts that satisfy the selections of the groups and categories of field 803. Alternately, the system can wait until all fields and categories have been selected and then search the contacts and populate field 804.

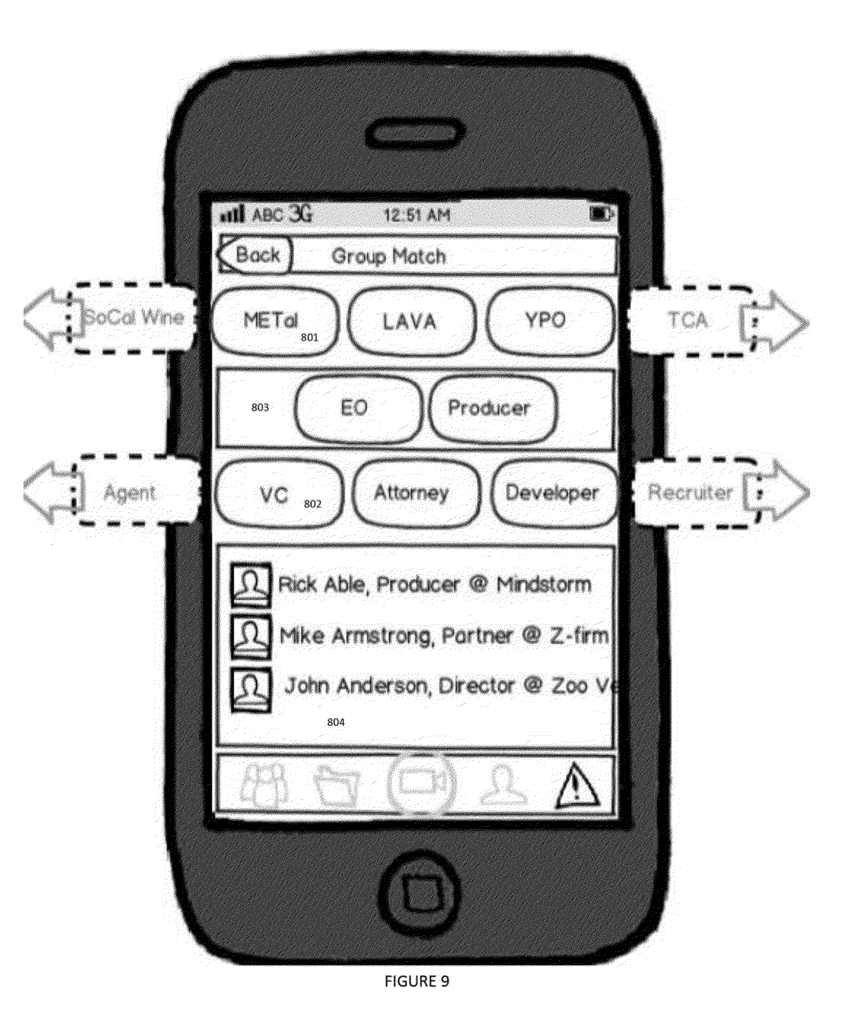

FIG. 9 is an example of the display after a group search has been performed. Field 803 shows that one group (ED) and one category (Producer) has been dragged in. Field 804 now displays all contacts who are in that group and in that category.

Geographic Sorting

Another feature of the system is geographic sorting of contacts. The system provides a map and allows the user to pick a location and a zoom level of the map. This map can be accessed from the contact-centric region of the display. The system then shows pins or some other indicator on the map of all contacts in the user's list within some user defined distance from the location. When the user is travelling, it may be useful to have a visual reminder of the contacts that are nearby so that the user can plan face to face meetings with the contact B providing the visual reminder, the user will be prompted to meet with contacts that might otherwise not have come to mind.

Group Management

In one embodiment, a group may encourage members to subscribe or use the system herein. For users in the system, the group leader can use it for roster control and attendance tracking at meetings. After a group meeting, the group leader can send out a communication of all contacts that were at the group, as well as an indicator of the date of the meeting. In this manner, a user may view a group and not only see contacts in that group, but also the meetings that were attended by each contact. This provides some additional common ground when communicating, with a contact. Even if a group member did not attend, the user might initiate a communication to update the contact on what was said at the meeting, showing value and increasing contact communication. The group administrator, (the person who signed up the group on the system, would be able to download and send group videos, minutes of the meetings, etc. to the group members with this application. This multimedia would appear on the users group screen for that particular group above the group contacts and be displayed on a horizontal bar chronologically. Swiping, clicking, or some other gesture would reveal additional group meeting multimedia.

System Dashboard

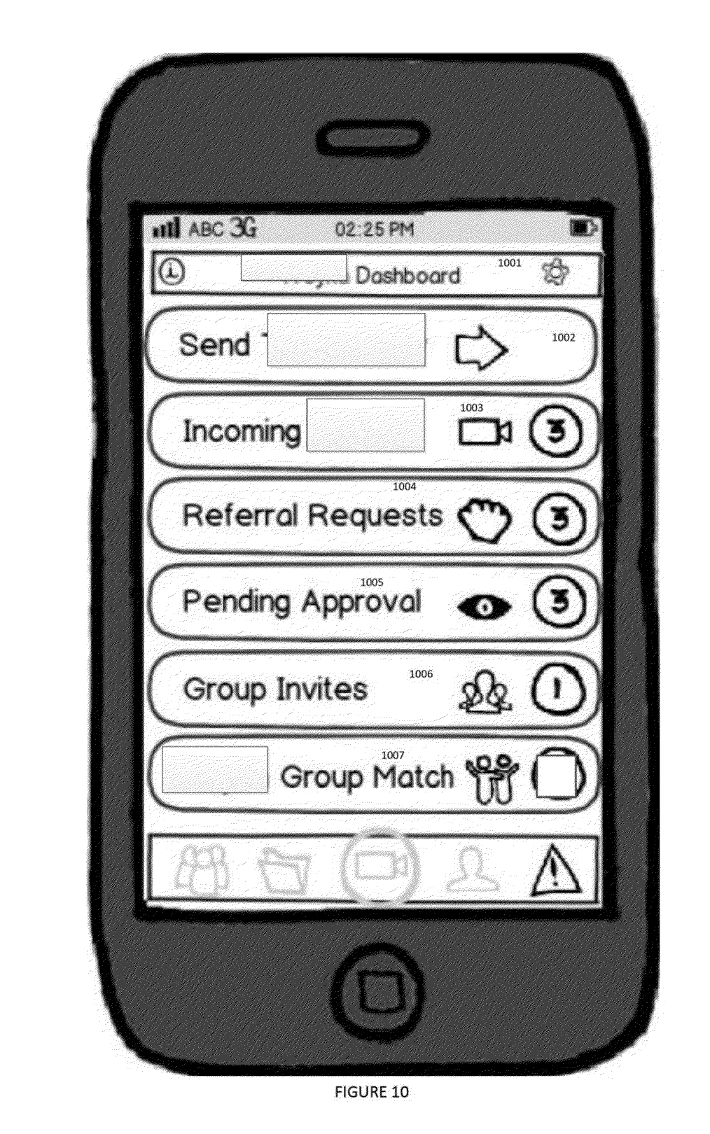

FIG. 10 illustrates an embodiment of the user dashboard of the system. The system is interactive with the user, indicating when videos, audio or text is received from contacts, when referrals have been received, and when invitations to groups are received. The display may indicate in region 1001 that the user is in dashboard mode, or alternately, that region may show the groups of which the user is a member. Region 1002 is used to initiate the sending of a multimedia clip to a contact from that users “profile” page. Sending contact's clips is done on the individual contact page.

Region 1003 shows how many incoming dips the user has pending for accepting and review. Region 1004 shows the number of referral requests that the user has outstanding and region 1005 shows referrals made on behalf of the user for which the user must grant approval.

Region 1006 shows invitations to join groups and includes an indicator of the number of group invitations that are pending (e.g. 1 in FIG. 10). Region 1007 initiates a group match operation as described in conjunction with FIG. 8 and FIG. 9 above.

Referral Process

One of the features of the system is the manner in which it enables and tracks referrals from one contact to another. It is believed that making referrals for others is an effective tool for getting referrals back to yourself, and is thus a business tool that can be quite useful. The current art does not provide an optimized system for creating, sending, and tracking referrals as does the present system.

Information

One unique aspect of the system is that it requests and guides each user into providing the type of information that makes it easy to provide referrals to the user. For example, the multimedia clips specifically ask the user to describe what they do. This is helpful because even a business card and job title do not really provide the kind of information needed to inform a contact of the types of things that a user does. It may be possible for a contact to look you up on a web site to see if there is any useful information, that might help in understanding what you do, but the present system collects it all in one consistent and expected place.

Another piece of information that the system requests, and that the user is encouraged to provide in a multimedia clip, is to identify the types of contacts to whom the user would like to be referred. Often, a friend or colleague does not know or realize the most useful contact for a referral. This information makes it easier for a friend or colleague to provide assistance in referrals.

Making a Referral

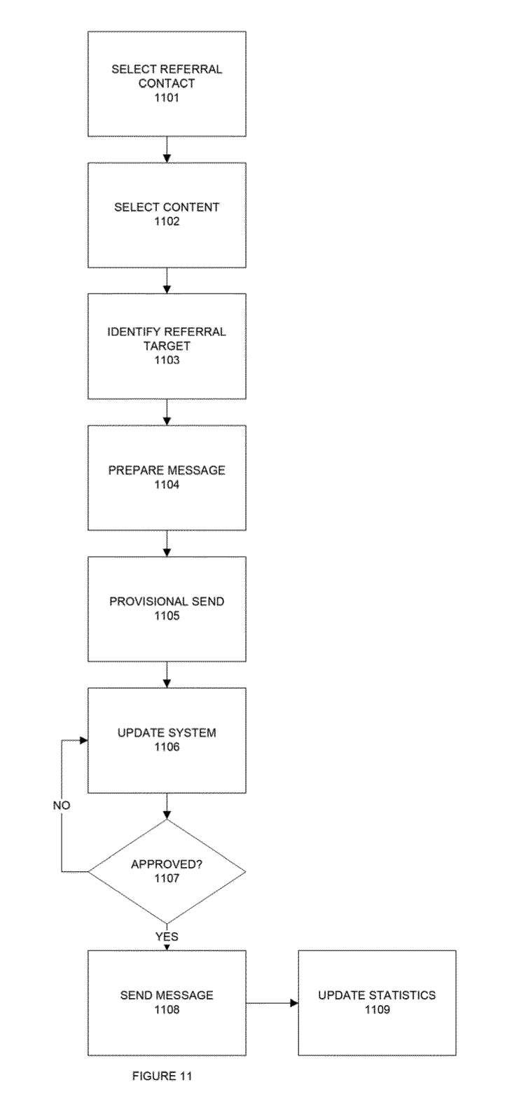

FIG. 11 is a flow diagram illustrating an embodiment of the system during the referral process. At step 1101, the user selects a referral contact. That is the user selects a contact on whose behalf he would like to make a referral. At step 1102 the user selects the content of that contact to provide with the referral. This may be one, some or all of the multimedia clips associated with that contact and that have been forwarded to the user.

At step 1103 the user selects the referral target, that is the person to whom the referral will be sent. At step 1104 the user prepares a message to the referral target. In one embodiment of the system, a plurality of referral templates may be provided that that can be autocompleted as appropriate for the user, referral contact, and the referral target. In other instances, the templates may be a guide for the type of message that might be appropriate. The goal is to explain to the referral target why you have chosen this referral contact for the referral.

At step 1105 the message is sent provisionally. That means that first the message is sent to the referral contact so that the referral contact may approve or reject the message and/or the target (in some cases there may be more than one referral target, and the referral contact may reject one or more of the targets). At step 1106 the system is updated so that the sender and referral contact can track the pending referral. Referring briefly to the dashboard of FIG. 10, the user will see an indicator in region 1004 that they have made a referral request. The referral contact will see an indicator in region 1005 that they have a referral pending their approval.

Referring back to FIG. 11, at decision block 1107 it is determined if the referral contact has approved the referral. If not, the system returns to step 1106. If so, the system proceeds to step 1108 and sends the referral to the referral target. At step 1109 the system updates the statistics for all parties to reflect the referral transaction. The user will show an additional referral that has been made. The user's profile for both the target and the referral contact will reflect that the user has made a referral directed to or from one of them.

Gate Keeper

One of the types of relationships that can be defined in the system is gatekeeper status. A user may have a trusted list of vendors or professionals that the user relies on. The user may opt to allow people to see this list but have gatekeeper status over the list. This means that other users cannot contact those parties without the permission of the gatekeeper. Consider where you are in a gatekeeper list of Contact A. Contact B sees that Contact A has identified you as a trusted expert. Contact B reaches out to Contact A and asks for a referral to you. Contact A would send a request to you for permission to forward your information to contact 13.

Embodiment of Computer Execution Environment (Hardware)

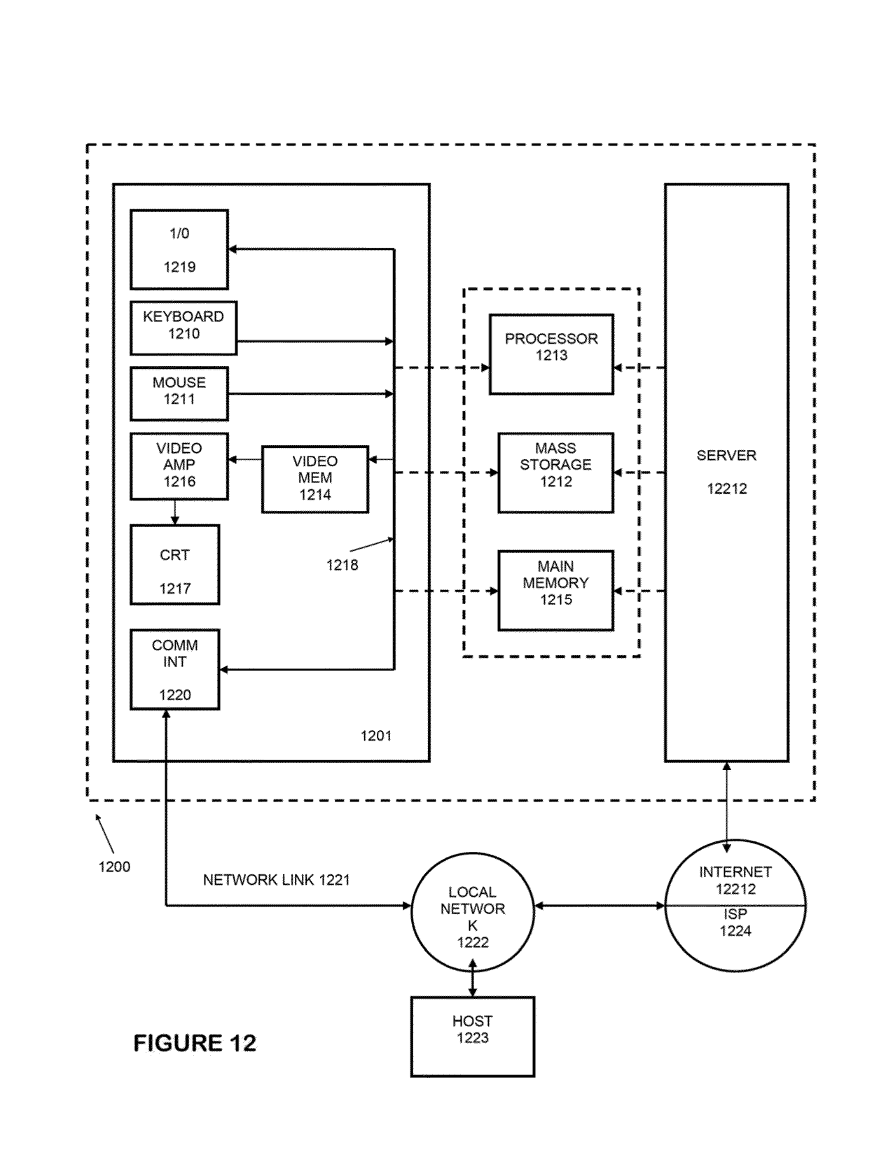

An embodiment of the system can be implemented as computer software in the form of computer readable program code executed in a general purpose computing environment such as environment 1200 illustrated m FIG. 12, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 1210 and mouse 1211 are coupled to a system bus 1218. The keyboard and mouse are for introducing user input to the computer system and communicating that user input to central processing unit (CPU 1213. Other suitable input devices may be used in addition to, or in place of the mouse 1211 and keyboard 1210. I/O (input/output) unit 1219 coupled to bi-directional system bus 1218 represents such I/O elements as a printer, A/V (audio/video) I/O, etc.

Computer 1201 may be a laptop, desktop, tablet, smart-phone, or other processing device and may include a communication interface 1220 coupled to bus 1218. Communication interface 1220 provides a two-way data communication coupling via a network link 1221 to a local network 1222. For example, if communication interface 1220 is an integrated services digital network (ISDN) card or a modern, communication interface 1220 provides a data communication connection to the corresponding type of telephone line, which comprises part of network link 1221. If communication interface 1220 is a local area network (LAN) card, communication interface 1220 provides a data communication connection via network link 1221 to a compatible LAN. Wireless links are also possible. In any such implementation, communication interface 1220 sends and receives electrical, electromagnetic or optical signals which carry digital data streams representing various types of information.

Network link 1221 typically provides data communication through one or more networks to other data devices. For example, network link 1221 may provide a connection through local network 1222 to local server computer 1223 or to data equipment operated by ISP 1224. ISP 1224 in turn provides data communication services through the world wide packet data communication network now commonly referred to as the “Internet” 12212 Local network 1222 and Internet 12212 both use electrical, electromagnetic or optical signals which carry digital data streams. The signals through the various networks and the signals on network link 1221 and through communication interface 1220, which carry the digital data to and from computer 1200, are exemplary forms of carrier waves transporting the information.

Processor 1213 may reside wholly on client computer 1201 or wholly on server 12212 or processor 1213 may have its computational power distributed between computer 1201 and server 12212. Server 12212 symbolically is represented in FIG. 12 as one unit, but server 12212 can also be distributed between multiple “tiers”. In one embodiment, server 12212 comprises a middle and hack tier where application logic executes in the middle tier and persistent data is obtained in the back tier, in the case where processor 1213 resides wholly an server 12212, the results of the computations performed by processor 1213 are transmitted to computer 1201 via Internet 12212, Internet Service Provider (ISP) 1224, local network 1222 and communication interface 1220. In this way, computer 1201 is able to display the results of the computation to a user in the form of output.

Computer 1201 includes a video memory 1214, main memory 1215 and mass storage 1212, all coupled to bi-directional system bus 1218 along with keyboard 1210, mouse 1211 and processor 1213.

As with processor 1213, in various computing environments, main memory 1215 and mass storage 1212, can reside wholly on server 12212 or computer 1201, or they may be distributed between the two. Examples of systems where processor 1213, main memory 1215, and mass storage 1212 are distributed between computer 1201 and server 12212 include thin-client computing architectures and other personal digital assistants, Internet ready cellular phones and other Internet computing devices, and in platform independent computing environments,

The mass storage 1212 may include both fixed and removable media, such as magnetic, optical or magnetic optical storage systems or any other available mass storage technology. The mass storage may be implemented as a RAID array or any other suitable storage means. Bus 1218 may contain, for example, thirty-two address lines for addressing video memory 1214 or main memory 1215. The system bus 1218 also includes, for example, a 32-bit data bus for transferring data between and among the components, such as processor 1213, main memory 1215, video memory 1214 and mass storage 1212. Alternatively, multiplex data/address lines may be used instead of separate data and address lines.

In one embodiment of the invention, the processor 1213 is a microprocessor such as manufactured by Intel, AMD, Sun, etc. However, any other suitable microprocessor or microcomputer may be utilized, including a cloud computing solution. Main memory 1215 is comprised of dynamic random access memory (DRAM). Video memory 1214 is a dual-ported video random access memory. One port of the video memory 1214 is coupled to video amplifier 1219. The video amplifier 1219 is used to drive the cathode ray tube (CRT) raster monitor 1217. Video amplifier 1219 is well known in the art and may be implemented by any suitable apparatus. This circuitry converts pixel data stored in video memory 1214 to a raster signal suitable for use by monitor 1217. Monitor 1217 is a type of monitor suitable for displaying graphic images.

Computer 1201 can send messages and receive data, including program code, through the network(s), network link 1221, and communication interface 1220. In the Internet example, remote server computer 12212 might transmit a requested code for an application program through Internet 12212, ISP 1224, local network 1222 and communication interface 1220. The received code maybe executed by processor 1213 as it is received, and/or stored in mass storage 1212, or other non-volatile storage for later execution. The storage may be local or cloud storage. In this manner, computer 1200 may obtain application code in the form of a carrier wave. Alternatively, remote server computer 12212 may execute applications using processor 1213, and utilize mass storage 1212, and/or video memory 1215. The results of the execution at server 12212 are then transmitted through Internet 12212, ISP 1224, local network 1222 and communication interface 1220. In this example, computer 1201 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. In other embodiments, the system may be implemented on any suitable computing environment including personal computing devices, smart-phones, pad computers, and the like. An embodiment of the invention may be implemented in any type of computer system or programming or processing environment.

While the system has been described with respect to a limited number of embodiments, it will be appreciated that many variations, modifications, and other applications of the system may be made.

What is claimed is:

1. A method of maintaining contacts comprising:
In a computer system;
Storing a contact profile in a database;
Associating at least one multimedia clip with the contact profile;
Displaying a contact-centric toolbar with the profile of the contact that causes functions to be associated with the specific contact.

2. The method of claim 1 wherein the multimedia clip is a video clip.

3. The method of claim 2 wherein the multimedia clip is limited to a specific time length.

4. The method of claim 1 further including forwarding a referral of a first contact to a second contact upon the approval of the first contact.

5. The method of claim 4 further including, tracking of all referrals made using the system.

6. The method of claim 1 further including, displaying a map associated with the contact and identifying all other contacts within a specified distance of the contact.

7. The method of claim 2 further including creating a video clip using the system wherein a user selects a type and length of video clip; the system provides a suggested teleprompter script, and the system displays the teleprompter script during recording.

8. The method of claim 7 wherein the user may edit the teleprompter script.

9. The method of claim 2 wherein the system provides a plurality of pre-set business clips to stimulate a user to create those clips.

10. The method of claim 1 further including creating a group comprising a plurality of contacts and wherein contact information and multimedia clips can be exchanged within the group.
